(19) United States
(12) Patent Application Publication
(10) Pub. No.: US 2007/0001572 A1
(43) Pub. Date: Jan. 4, 2007

(54) Method for forming an electrode of a surface light source, surface light source device manufactured by using the same, and display device having the same

(75) Inventors: Hae-Il Park, Seoul (KR); Sang-Yu Lee, Yongin-si (KR); In-Sun Hwang, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/472,185

(22) Filed: Jun. 21, 2006

(30) Foreign Application Priority Data
Jul. 1, 2005 (KR) 10-2005-0059168

(51) Int. Cl. H01J 11/00; H01J 65/00; H01J 61/06

(52) U.S. Cl. 313/234; 313/607

(57) ABSTRACT

A method for forming an electrode of a surface light source device includes: contacting channel end portions of the surface light source device having a plurality of channels with a first solution and forming an electroless plating seed layer on surfaces of the channel end portions; removing the surface light source device from contact with the first solution and heating the surface light source device; and contacting the surface light source device with a second solution and forming an electrode by using electroless plating.

### CROSS-REFERENCE TO RELATED PATENT APPLICATIONS

This application claims priority to Korean patent application No. 2005-0059168, filed on Jul. 1, 2005, the contents of which are herein incorporated by reference in their entirety.

### BACKGROUND OF THE INVENTION

1. Technical Field

The present disclosure relates to a method for forming an electrode of a surface light source, a surface light source device manufactured by using the method, and a display device having the surface light source device.

2. Discussion of Related Art

With the rapid advances in semiconductor technologies, user demands for light weight, compact display devices have increased.

Common display device types are analog electronic displays, such as a cathode ray tube (CRT) display, and digital electronic displays, including liquid crystal display (LCD), plasma display panel (PDP), and organic light emitting display (OLED). Digital electronic display devices have largely replaced the conventional cathode ray tube (CRT) as the display device used for TV sets and computer monitors.

A liquid crystal display generates an electric field in a liquid crystal layer by applying voltages to field generating electrodes. When an electric field is applied, the liquid crystal molecules of the liquid crystal layer are tilted at angles dependent on the strength of the electric field. The liquid crystal display device displays images by controlling the strength of the electric field, which determines orientations of the liquid crystal molecules to adjust polarization of incident light.

Since liquid crystal displays are non-emission type displays, they rely on an external light source. LCDs can be transmissive, reflective, or transflective (a combination of reflective and transmissive types), depending on the location of the light source. A transmissive LCD is illuminated by a backlight. This type of LCD is widely used in computer displays, mobile phones and other applications requiring high luminance levels. In the case of a large-sized liquid crystal display panel such as a digital TV, a plurality of lamps are used as the backlight and the assembly process is complicated. In addition, as the thickness of the backlight assembly is increased to prevent breakage of the fragile lamps, the overall thickness of the liquid crystal display device is also increased.

Surface light source devices capable of emitting light by discharging a gas are available. This type of surface light source device, in which an interior surface is coated with a phosphor, includes a plurality of electrodes. By applying voltages to the electrodes, the gas contained in the surface light source device is discharged to generate ultraviolet light. The ultraviolet light excites the phosphor atoms which then emit visible light.

In cases where the electrodes are disposed externally of the surface light source device, parallel driving can be available, and voltage variations between channels of the surface light source device can be reduced. Various methods of forming the electrodes externally of the surface light source device have been developed, including a spray coating method and a spin coating method. When using the spray coating method or the spin coating method, it is very important to maintain the adhesiveness between a metal portion constituting electrodes and a glass portion constituting the outer surface of the surface light source device. When using the spray coating method or the spin coating method, a binder can be added to increase an adhesive force between the glass portion and the metal portion.

Although the use of a binder can increase the adhesive force, the binder may reduce the electric and thermal conductivities of the electrodes, and soldering is difficult to perform. When the thermal conductivity of the electrodes is lowered, pin holes are more easily formed in the electrodes. Additional metal patches can be formed over the solders of the electrodes, after which the spray coating or spin coating method is performed.

In a dipping method of forming the electrodes of the surface light source device, since a lead-free solder is used, the electrodes may be lost due to heat, and since the conductively of the electrodes is lowered, pin holes may appear on the electrode surfaces. In cases where other metals are used as a substitute for the lead-free solder, a sand blasting process or a chemical etching process is generally performed on the glass portion to improve adhesiveness with the glass portion. In such cases, a surface of the glass portion may be easily damaged and broken.

### SUMMARY OF THE INVENTION

According to an exemplary embodiment of the present invention, a method for forming an electrode of a surface light source for a surface light source device comprises steps of: contacting channel end portions of the surface light source device having a plurality of channels with a first solution and forming an electroless plating seed layer on surfaces of the channel end portions; removing the surface light source device from contact with the first solution and heating the surface light source device; and contacting the surface light source device with a second solution and forming a plurality of electrodes by using electroless plating.

The plurality of channels may comprise two side channels and a plurality of interior channels and, in the step of forming the electroless plating seed layer, an area of the seed of each of the side channels may be formed to be larger than an area of each of the interior channels.

In the step of forming the electroless plating seed layer, the first solution may be an aqueous solution containing Pd ions, and the electroless plating seed layer may comprise Pd.

In the step of heating the surface light source device, Sn may be removed from the channel end portions. In the step of heating the surface light source device, Pd may be extracted after Sn is removed.

In the step of contacting the surface light source device with a second solution and forming an electrode by using electroless plating, the second solution may contain at least one of Cu ions, EDTA (ethylene diamine tetraacetic acid), sodium hydroxide (NaOH), or formaldehyde.

The electrode may comprise Cu.

In the step of heating the surface light source device, the surface light source device may be heated at a temperature ranging from about 200° C. to about 300° C.

According to an exemplary embodiment of the present invention, there is provided a surface light source device manufactured by using the above-described electrode forming method.

The electrode areas of each of the side channels of the channels may be larger than those of each of the interior channels.

The electrodes formed on the side channels may be formed to extend in a longitudinal direction of the channels.

The thickness of the electrodes may be in a range of about 0.01 μm to about 1.00 μm.

According to an exemplary embodiment of the present invention, there is provided a display device comprising: a panel unit for displaying an image; and the above-described surface light source device for supplying light to the panel unit.

The panel unit may be a liquid crystal display panel.

### BRIEF DESCRIPTION OF THE DRAWINGS

The present invention will become readily apparent to those of ordinary skill in the art when descriptions of exemplary embodiments thereof are read with reference to the accompanying drawings.

FIG. 1 is a schematic perspective view showing a surface light source device according to an exemplary embodiment of the present invention.

FIG. 2 is a cross sectional view taken along line II-II of FIG. 1.

FIG. 3 is a flowchart showing a method of forming an electrode for a surface light source device according to an exemplary embodiment of the present invention.

FIG. 4 is a view showing a step of forming electrodes in the surface light source device by using a dipping apparatus according to an exemplary embodiment of the present invention.

FIG. 5 is a view showing a step of forming electrodes in the surface light source device by using a dipping apparatus according to an exemplary embodiment of the present invention.

FIG. 6 is an exploded perspective view showing a display device having the surface light source device of FIG. 1, according to an exemplary embodiment of the present invention.

FIG. 7 is a block diagram showing a configuration of a panel unit included in the display device of FIG. 6, according to an exemplary embodiment of the present invention.

FIG. 8 is an equivalent circuit diagram showing a pixel of a panel unit according to an exemplary embodiment of the present invention.

### DESCRIPTION OF EXEMPLARY EMBODIMENTS

Hereinafter, exemplary embodiments of the present invention will be described in detail with reference to the accompanying drawings. Like reference numerals refer to similar or identical elements throughout the description of the figures.

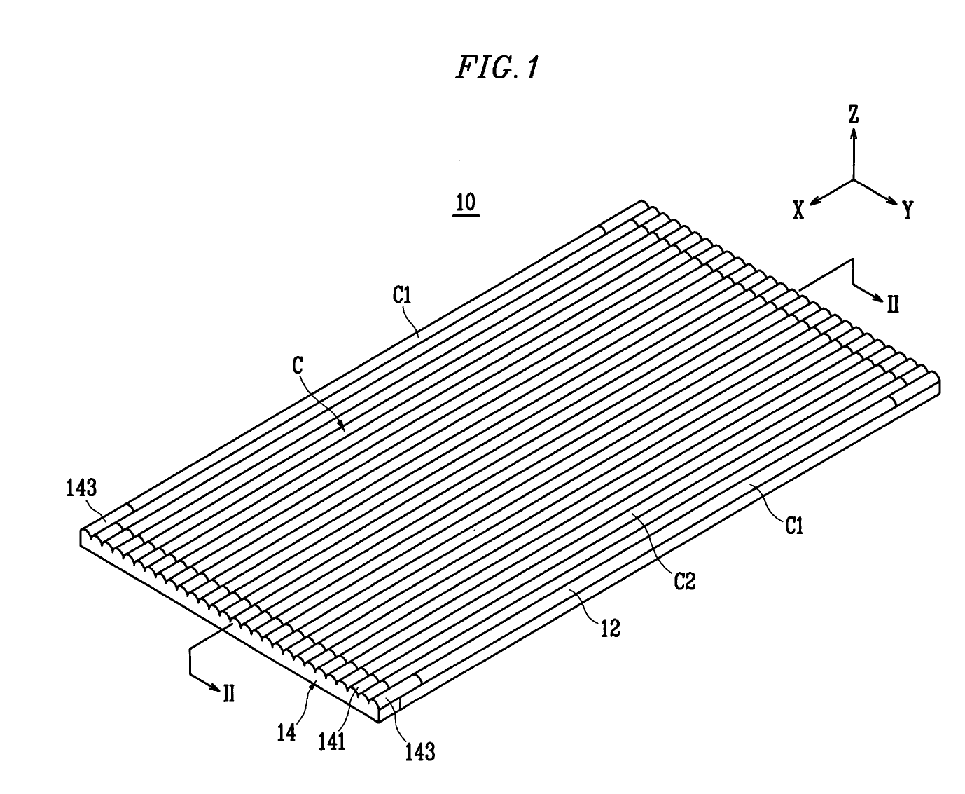

FIG. 1 shows a surface light source device 10 according to an exemplary embodiment of the present invention.

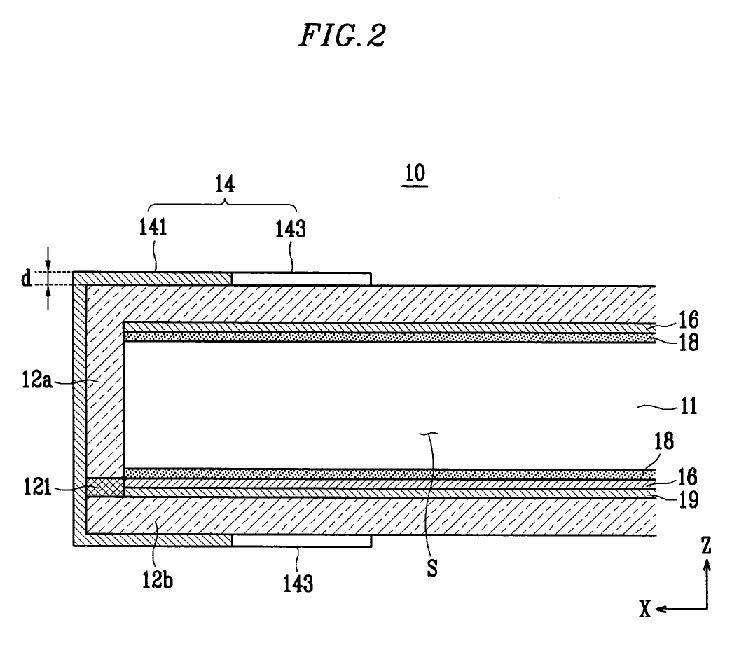

Referring to FIG. 1, the surface light source device 10 is covered by a glass substrate 12. A plurality of channels C are provided to the surface light source device 10. As shown in FIG. 1, the channels C include two side channels C1, disposed at the sides of the light device 10, and a plurality of interior channels C2. The channels C are formed to extend along the X axis direction in FIG. 1. Each of the channels C is isolated by a partition wall 11 (shown in FIG. 2) which is formed in an inner portion of the surface light source device 10.

In an exemplary embodiment of the present invention, electrode areas of each of the two side channels C1 are formed to be larger than those of each of the interior channels C2. Electrodes 14 shown in FIGS. 1 and 2 comprise electrodes of the two side channels C1, which are referred to herein as complementary electrodes 143, and electrodes of the interior channels C2, which are referred to herein as general electrodes 141. Therefore, the electrodes 14 comprise the complementary electrodes 143 and the general electrodes 141.

Due to factors including for example temperature variation and inter-channel coupling, the brightness of the two side channels C1 is lower than that of the interior channels C2. In an exemplary embodiment of the present invention, capacitance is increased by providing the complementary electrodes 143 to the two side channels C1. When the complementary electrodes 143 are provided, current increases, brightness increases and brightness uniformity can be maintained.

The area of each of the complementary electrodes 143 is designed to be larger than that of each of the general electrodes 141, and dark portions resulting from the brightness variation between the channels C of the surface light source device 10 may be minimized. The widths (Y axis direction in FIG. 1) of the channels C are substantially equal to each other. The complementary electrodes 143 are formed to extend along the longitudinal direction of the two side channels C1. The lengths (X axis direction in FIG. 1) of the complementary electrodes 143 are designed to be larger than that of the general electrodes 141.

FIG. 2 is a cross sectional view taken along line II-II of FIG. 1 and shows an internal structure of the surface light source device 10, according to an exemplary embodiment of the present invention.

Referring to FIG. 2, the surface light source device 10 comprises an upper substrate 12a and a lower substrate 12b. The lower substrate 12b is coated with a frit or solder glass to seal the upper and lower substrates 12a and 12b. End portions of the surface light source device 10 are covered by the electrodes 14. Although not shown in FIG. 2, the electrodes 14 can be connected to external wire lines so that external voltages can be, applied across the electrodes 14. An internal space S of the surface light source device 10 is filled with an inert gas, such as for example, Xe and Ar. When the voltage is applied across the electrodes 14, the gas is discharged to generate ultraviolet light. The ultraviolet light excites the phosphor atoms of a phosphor layer 18, which then emit visible light. The phosphor layer 18 is disposed on an upper portion of the surface light source device 10. The phosphor layer 18 is transparent, and the light can emit from the upper portion of the surface light source device 10. A reflective layer 19 comprising Ag or the like is disposed on a lower portion of the surface light source device 10. Light emitting toward the lower portion of the surface light source device 10 is reflected on the reflective layer 19 toward the upper portion, and loss of light is minimized and brightness can be improved.

To prevent the electrodes 14 from being broken by the electrons emitting from the electrodes 14, a dielectric layer 16 may be provided. The dielectric layer 16 may protect the electrodes 14.

The thickness d of the electrodes 14 formed by using an electroless plating method in accordance with an exemplary embodiment of the present invention is in a range of about 0.01 μm to about 1.00 μm. If the thickness d of the electrodes 14 is less than 0.01 μm, the electrodes are so thin that pin holes may be formed. If the thickness d of the electrodes 14 is more than 1.00 μm, the electrodes are so thick that electric conductivity and thermal conductivity may be lowered.

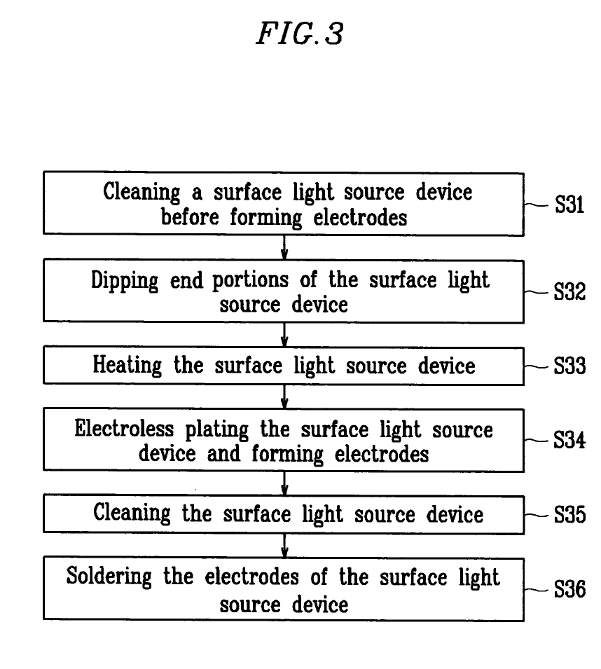

Hereinafter, a method of forming an electrode of the surface light source device 10 shown in FIG. 2, according to an exemplary embodiment of the present invention, will be described with reference to FIG. 3.

FIG. 3 is a flowchart showing a method of forming an electrode of a surface light source device according to an exemplary embodiment of the present invention. One of ordinary skill in the art can readily appreciate that some of the steps shown in FIG. 3 are optional and may be omitted.

An electroless plating method, according to an exemplary embodiment of the present invention, is performed through a chemical reaction without using electricity. Since a glass substrate is not a conductive material, electroplating cannot be performed on the glass substrate. However, by using an electroless plating method, electrodes can be formed on the glass substrate. Before the formation of the electrodes 14, the surface light source device 10 of FIG. 2 is prepared by assembling the upper substrate 12a with the lower substrate 12b. In Step S31, the surface light source device is cleaned before forming the electrodes. Contaminants may be removed from the glass substrate, for example, by using a surfactant. Due to the cleaning Step S31, the surface of the glass substrate is in a positively (+) activated state.

In Step S32, the end portions of the surface light source device are contacted with a first solution. In an exemplary embodiment of the present invention, the end portions of the surface light source device are dipped into the first solution. The first solution may comprise an aqueous solution containing Pd ions. The Pd enclosed by colloidal components serves as an electroless plating seed. An electroless plating seed layer is formed on the outer surfaces of the end portions of the channels of the surface light source device. The electroless plating seed layer comprises electroless plating seeds that are attached on the outer surfaces of the end portions of the channels in the form of a colloidal. Since the electrodes are formed at both sides of the surface light source device, both side end portions of the channels are contacted with the first solution. After one end portion of the surface light source device is dipped into the first solution, for example, the surface light source device is removed therefrom, and by turning the surface light source device upside down, the other end portion can be dipped. The electroless plating seeds are formed at both side end portions of the surface light source device.

In Step S33, the surface light source device is removed from contact with the first solution, and the surface light source device is heated. According to an exemplary embodiment of the present invention, a heating temperature is in a range of from about 200° C. to about 300° C. If the heating temperature is less than 200° C., the electroless plating seeds cannot easily be attached on the surface light source device. If the heating temperature is more than 300° C., cracking occurs in the surface light source device. When the surface light source device is heated, the Sn protecting the Pd enclosed by the colloidal components is removed from the end portions of the channels. Pd may be extracted in a metal state on the outer surface of the end portions of the channels.

Next, in Step S34, the electroless plating is performed on the surface light source device to form the electrodes. In an exemplary embodiment of the present invention, the surface light source device is contacted with a second solution comprising an electroless plating solution. The second solution comprises Cu ions, EDTA (ethylene diamine tetraacetic acid), sodium hydroxide (NaOH), and/or formaldehyde. It is to be understood that the second solution may contain various components.

When pH of the sodium hydroxide is increased to be more than 11, a strong reduction reaction is generated in the formaldehyde, and electrons are generated. The electrons move to the Cu ions in the second solution, and Cu is extracted on the Pd catalyst. The Pd catalyst is uniformly distributed on the outer surfaces of the end portions of the channels, and the Cu electrodes can be also uniformly coated thereon.

After the formation of the electrodes, in Step S35, the surface light source device is cleaned. For example, contaminants may be removed from the surfaces of the electrodes, and soldering may be easier to perform on the cleaned surfaces of the electrodes.

In Step S36, wire lines are connected to the electrodes, for example, with solder. Through the wire lines, external voltages are applied to the electrodes so as to drive the surface light source device.

According to the above described method, the electrodes of the surface light source device can be formed at a high speed. In addition, electrodes having an irregular shape can be easily formed. In addition, since the electrodes plating method is used, adhesiveness between the glass substrate and the metal electrodes can be improved. In addition, good soldering characteristics and suitable strength of the electrodes can be obtained. When a suitable thickness of the electrodes is formed by using Cu, an oxide film is formed on the surfaces of the Cu electrodes. Therefore, there is no need to form an additional oxide. Namely, when the electrodes formed by using the above described electroless plating method are heated, a dense oxide film is formed on the surfaces thereof. When the oxide film is formed to have a predetermined thickness or more, the oxide film blocks external oxygen from penetrating, so that and the formation of oxide film is stopped.

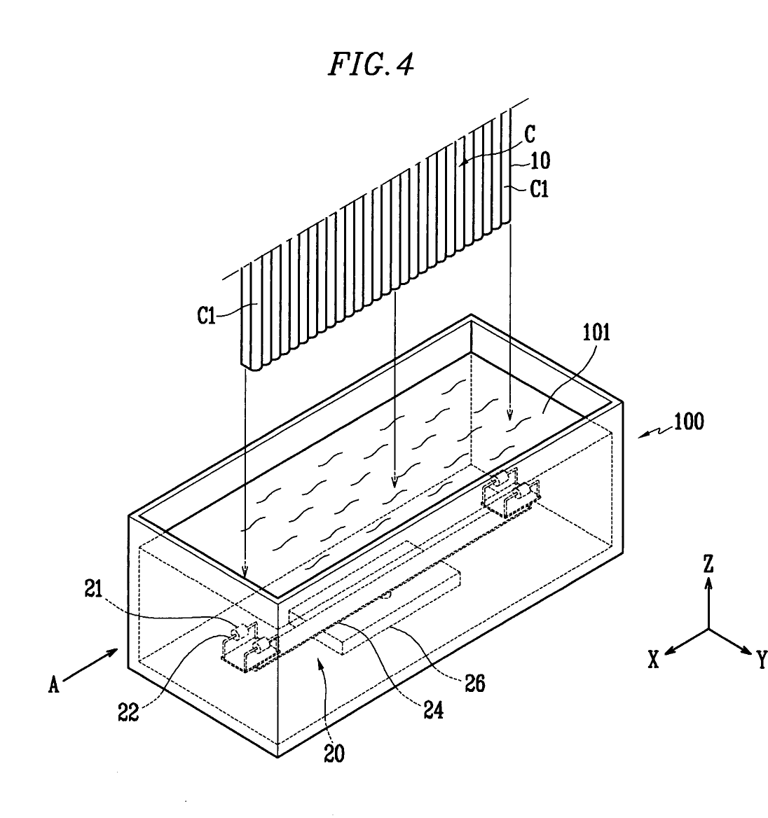

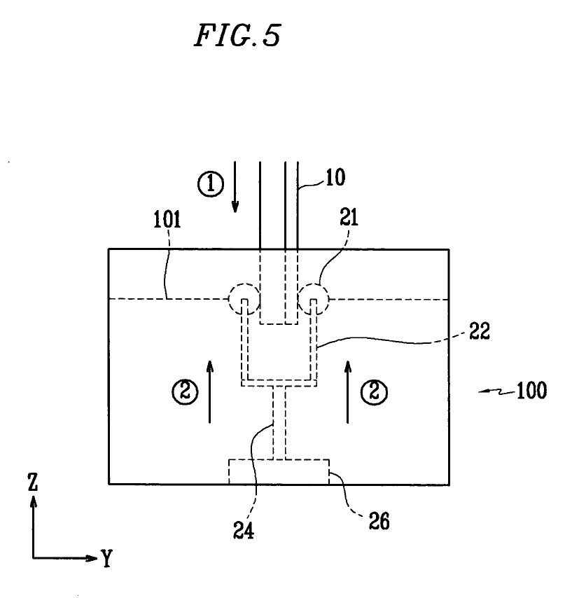

Hereinafter, Step S32 of FIG. 3 will be described in detail with reference to FIGS. 4 and 5. The dipping step shown in FIGS. 4 and 5 is an example of the present invention, but the present invention is not limited thereto. The dipping step may be modified in various manners.

FIG. 4 shows a step of forming electrodes in the surface light source device 10 by using a dipping apparatus 100.

A dipping solution 101 is contained in the dipping apparatus 100. The surface light source device 10 is dipped into the dipping solution 101 in the arrow direction, and electroless plating seeds are formed on the outer surfaces of the end portions of the channels C.

The dipping apparatus 100 includes a dipping solution coating unit 20. By using the dipping solution coating unit 20, the electroless plating seeds can be formed with a wide area on both side channels C1 of the channels C. In FIG. 4, the dipping solution coating unit 20 is shown with dotted lines.

The dipping solution coating unit 20 includes a plurality of rollers 21, roller supporting members 22, and a roller driving member 24, and a base plate 26. As needed, other parts may be included.

A pair of the roller 21 are provided to each side of the dipping solution coating unit 20. By using the rollers 21, the outer surfaces of the channels of the surface light source device 10 are coated with the dipping solution. In the coating step, the rollers 21 are driven to move in the upward direction (+Z axis direction) when the surface light source device 10 is dipped. The rollers 21 are supported by the roller supporting member 22. The roller driving member 24 fixed on the base plate 26 moves in the upward direction to push the roller supporting member 22, so that the rollers 21 can be lifted up. As a result, only the channels C1 can be coated with the electroless plating seeds with wider areas thereof.

FIG. 5 is a view showing a step of forming electrodes in the surface light source device 10 by using a dipping apparatus 100 as seen in direction A of FIG. 4, according to an exemplary embodiment of the present invention.

Referring to FIG. 5, in Step □, the surface light source device 10 is dipped into the dipping solution 100 in the arrow direction. When the surface light source device 10 is dipped into the dipping solution 101, the electroless plating seeds are formed on the end portions of the channels. Next, in Step □, the roller 21 moves the surface light source device 10 in the arrow direction (upward direction). The rollers 21 coat the electroless plating seeds at only the two side channels C1. The rollers 21 may be formed to have a brush-shaped surface, for example, so that the electroless plating seeds can be coated on the rounded/curved surfaces of the channels of the surface light source device 10. By using the above-described steps, the surface light source device 10 according to an exemplary embodiment of the present invention shown in FIG. 1 can be manufactured.

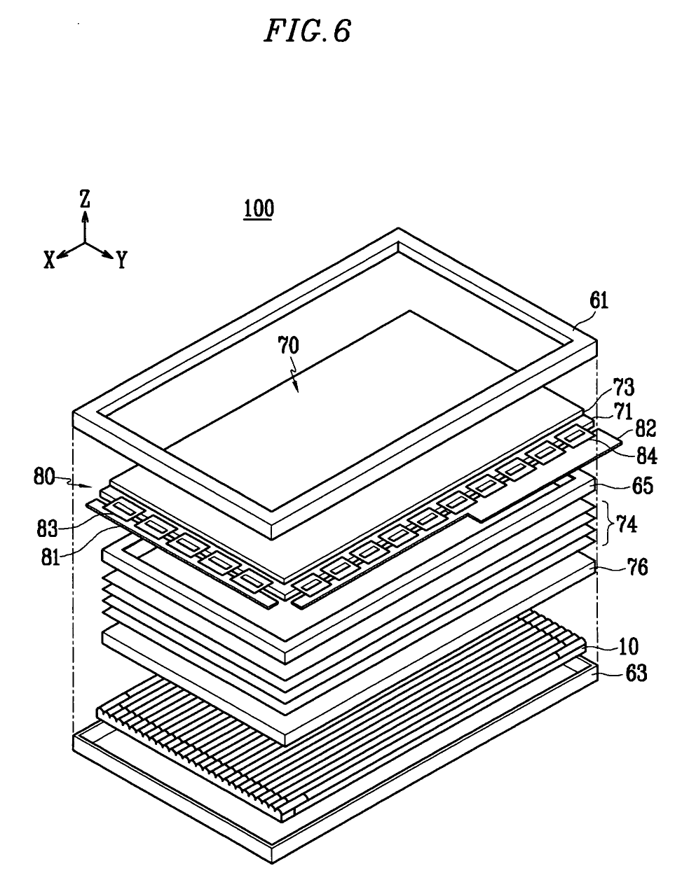

FIG. 6 shows a display device 100 having the surface light source device 10 of FIG. 1, according to an exemplary embodiment of the present invention.

Referring to FIG. 6, the surface light source device 10 is contained in a bottom chassis 63. An inverter (not shown) which converts an external voltage to a predetermined level of the driving voltage and applies the driving voltage to the surface light source device 10 is disposed on a rear surface of the bottom chassis 63. The surface light source device 10 is electrically connected to the inverter such as through wire lines.

Light emitting from the surface light source device 10 passes through a diffuser plate 76 so as to be uniformly diffused. To obtain uniform brightness, the diffuser plate 76 is disposed to be separated by a predetermined distance from the surface light source device 10. Light uniformly diffused by the diffuser plate 76 passes through a plurality of optical sheets 74. A prism sheet included in the optical sheets 74 improves the straightness of the light, and the brightness of the light can be improved. The optical sheets 76 and the diffuser plate 74 can be attached to each other by using a middle chassis 65. The middle chassis 65 supports the panel unit assembly 80 disposed thereon.

The light is irradiated on the panel unit 70, so that the panel unit 70 can display an image. It is to be understood that, although the panel unit 70 of FIG. 6 is embodied as a crystal display panel, various non-emission type panels may be used.

The panel unit assembly 80 may be covered with a top chassis 61 so as to fix the panel unit 70. The panel unit assembly 80 includes the panel unit 70, driver IC packages (driver integrated circuit packages) 83 and 84, and printed circuit boards 81 and 82. As an example of the driver IC packages, COP (chip on film), TCP (tape carrier package), or the like may be used. The printed circuit boards 81 and 82 may be enclosed in side surface of the frame member 19.

The panel unit 70 includes a TFT (thin film transistor) panel 71 including a plurality of TFTs, a color filter panel 73 disposed over the TFT panel 71, and liquid crystal molecules (not shown) injected between the panels. Polarizing plates are attached on an upper portion of the color filter panel 73, and a lower portion of the TFT panel 71 to polarize light passing through the panel unit 70.

The TFT panel 71 is a transparent glass substrate where the TFTs are disposed in matrix. A source port of each TFT is electrically connected to a data line, and a gate port thereof is electrically connected to a gate line. A drain port of each TFT is electrically connected to a pixel electrode made of a transparent conductive material such as ITO (indium tin oxide).

When electric signals of the printed circuit boards 81 and 82 are input to the gate and data lines of the panel unit 70, the electric signals are transmitted to the gate and source ports of the TFT. According to the input of the electric signals, the TFT turns on of off, and an electric signal for forming an image is output to the drain port thereof.

On the other hand, the color filter panel 73 is disposed to face the TFT panel 71. The color filter panel 73 is a panel where RGB filters are formed by using a thin film formation process. The RGB filters represent predetermined colors when light passes the filters. A common electrode made of ITO is disposed on the entire surface of the color filter panel 73. When a power is supplied to the gate and source ports to turn on the TFT, an electric field is generated between the pixel electrode of the TFT panel 71 and the common electrode of the color filter panel 73. Due to the electric field, alignment angles of the liquid crystal molecules interposed between the TFT panel 71 and the color filter panel 73 change, so that transmittance of light changes, and a desired image can be obtained.

The printed circuit boards 81 and 82 which receive external image signals and apply driving signals to the gate and data lines are electrically connected to the driver IC packages 83 and 84 that are attached to the panel unit 70. To drive the display device 100, the gate printed circuit board 81 transmits gate driving signals, and the data printed circuit board 82 transmits data driving signals. Namely, the gate and data driving signals are applied through the driver IC packages 83 and 84 to the gate and data lines of the panel unit 70. A control board (not shown) is disposed on a rear surface of the backlight assembly 10. The control board is electrically connected to the data printed circuit board 82 to convert analog data signals to digital data signals and apply the digital data signals to the panel unit 70.

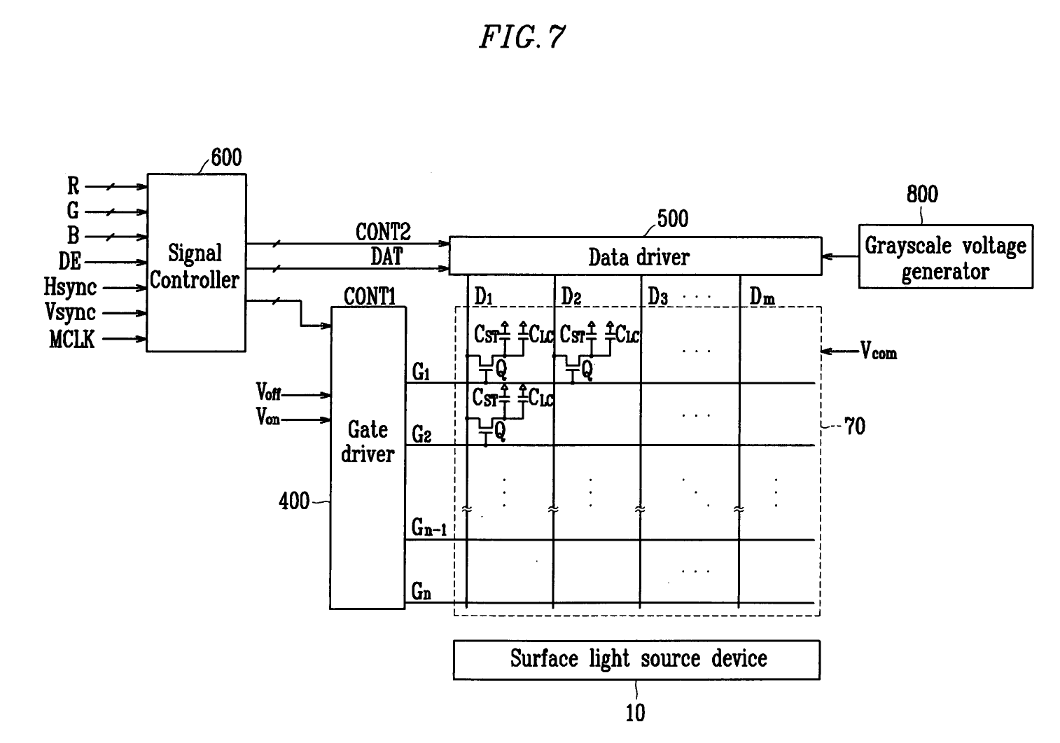

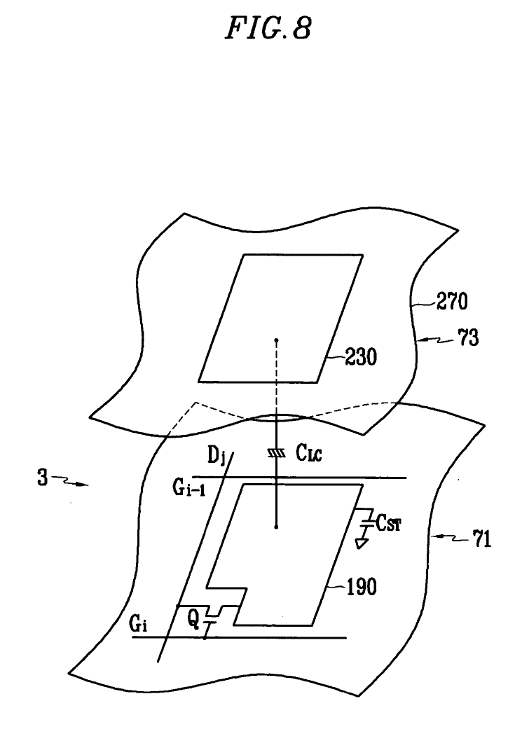

Hereinafter, operations of the panel unit 70 will be described in detail with reference to FIGS. 7 and 8.

The TFT panel 71 includes a plurality of display signal lines G₁ to Gₙ and D₁ to Dₘ. The color filter panel 73 and the TFT panel 71 include a plurality of pixels PX which are electrically connected to a plurality of the display signal lines G₁ to Gₙ and D₁ to Dₘ and arrayed substantially in a matrix.

The display signal lines G₁ to Gₙ and D₁ to Dₘ include a plurality of gate lines G₁ to Gₙ for transmitting gate signals (sometimes referred to as a “scan signal”) and a plurality of data lines D₁ to Dₘ for transmitting data signals. The gate lines G₁ to Gₙ extend in parallel to each other substantially in a row direction, and the data lines D₁ to Dₘ extend in parallel to each other substantially in a column direction.

Each of the pixels PX includes a switching device Q which is electrically connected to the display signal lines G₁ to Gₙ and D₁ to Dₘ, a liquid crystal capacitor C_{LC} connected thereto, and a storage capacitor C_{ST}. The storage capacitor C_{ST} may be omitted as needed.

The switching devices Q is a three-port device, such as a thin film transistor disposed in the TFT panel 71, and includes a control port which is electrically connected to one of the gate lines G₁ to Gₙ an input port which is electrically connected to the data line D₁ to Dₘ, and an output port which is electrically connected to the liquid crystal capacitor C_{LC} and the storage capacitor C_{ST}.

Two ports of the liquid crystal capacitor C_{LC} are a pixel electrode 190 of the TFT panel 71 and a common electrode 270 of the color filter panel 73. The liquid crystal layer 3 interposed between the two electrodes 190 and 270 serves as a dielectric member. The pixel electrode 190 is electrically connected to the switching device Q, and the common electrode 270 is disposed on the entire surface of the color filter panel 73 to receive a common voltage V_{com}. Alternatively, the common electrode 270 may be disposed on the TFT panel 71, and in this case, at least one of the two electrodes 190 and 270 may be formed in the shape of a line or bar.

The storage capacitor C_{ST} having an auxiliary function for the liquid crystal capacitor C_{LC} is constructed by overlapping a separate signal line (not shown) and the pixel electrode 190 provided to the TFT panel 71 with an insulating member interposed therebetween, and a predetermined voltage such as the common voltage V_{com} is applied to the separate signal line. Alternatively, the storage capacitor C_{ST} may be constructed by overlapping the pixel electrode 190 and a front gate line with an insulting member interposed therebetween.

The signal controller 600 receives input image signals R, G, and B and input control signals for controlling display thereof from an external graphic controller (not shown). The input control signals may include a vertical synchronization signal Vsync, a horizontal synchronization signal Hsync, a main clock MCLK, and/or a data enable signal DE. The signal controller 600 processes the input image signals R, G, and B according to an operating condition of the panel unit 70 (see FIG. 6) based on the input control signals and the input image signals R, G, and B to generate a gate control signal CONT1, a data control signal CONT2, and the like. The signal controller 600 transmits the generated gate control signal CONT1 to the gate driver 400 and transmits the generated data control signal CONT2 and the processed image signal DAT to the data driver 500.

The gate control signal CONT1 includes a scan start signal STV for indicating output start of the gate-on voltage Vₒₙ and at least one clock signal for controlling an output period of the gate-on voltage Vₒₙ and an output voltage.

The data control signal CONT2 includes a horizontal synchronization start signal STH for indicating transmission start of the image data DAT, a load signal LOAD for commanding to apply the associated data voltages to the data lines D₁ to Dₘ, and a data clock signal HCLK. The data control signal CONT2 also includes an inversion signal RVS for inverting a voltage polarity of the data signal with respect to the common voltage V_{com} (hereinafter, “the voltage polarity of the data signal with respect to the common voltage V_{com}” is abbreviated to “data signal polarity”).

In addition to the control signals CONT1 and CONT2, the signal controller 600 may transmit to the backlight assembly 10 other control signals and/or clock signals for controlling the operations of the backlight assembly 10.

In response to the data control signal CONT2 from the signal controller 600, the data driver 500 sequentially receives and shifts the digital image data DAT for one pixel row and selects the grayscale voltages corresponding to the digital image data DAT from the grayscale voltages supplied by the grayscale voltage generator 800, and the image data DAT are converted into the associated data voltages. After that, the data voltages are applied to the associated data lines D₁ to Dₘ.

The gate driver 400 applies the gate-on voltage Vₒₙ to the gate lines G₁ to Gₙ according to the gate control signals CONT1 from the signal controller 600 to turn on the switching devices Q which is electrically connected to the gate lines G₁ to Gₙ. As a result, the data voltages applied to the data lines D₁ to Dₘ are applied to the associated pixels PX through the turned-on switching devices Q.

A difference between the data voltages applied to the pixel PX and the common voltage V_{com} becomes a charge voltage of the liquid crystal capacitors C_{LC}, that is, a pixel voltage. Alignment of the liquid crystal molecules varies according to the intensity of the pixel voltage.

In units of one horizontal period (or 1H), that is, one period of the horizontal synchronization signal Hsync, the data driver 500 and the gate driver 400 repetitively perform the above described operations for the next pixel. In this manner, during one frame, the gate-on voltages Vₒₙ are applied to all the gate lines G₁ to Gₙ, and the data voltages are applied to all the pixels. When one frame ends, the next frame starts, and a state of the inversion signal RVS applied to the data driver 500 is controlled, and the polarity of the data signal applied to each of the pixels is opposite to the polarity in the previous frame (frame inversion). At this time, even in one frame, according to the characteristics of the inversion signals RVS, the polarity of the data signal flowing through the one data line may be inverted (row inversion and dot inversion). The polarities of the data signals applied to the one pixel row may be different form each other (column inversion and dot inversion).

According to an exemplary embodiment of the present invention, in a method for forming an electrode of a surface light source for a surface light source device, an electroless plating method is used, and it is possible to simply form electrodes.

According to an exemplary embodiment of the present invention, electrode areas of each of the side channels of the surface light source device are formed to be larger than those of interior channels, and the occurrence of dark portion caused from voltage variation may be prevented.

A surface light source device with a uniform brightness and high durability can be manufactured by using the above described electrode forming method of forming an electrode.

Although the exemplary embodiments of the present invention have been described in detail with reference to the accompanying drawings, it is to be understood that the inventive processes and apparatus should not be construed as limited thereby. It will be readily apparent to those of reasonable skill in the art that various modifications to the foregoing exemplary embodiments can be made without departing from the scope of the invention as defined by the appended claims, with equivalents of the claims to be included therein.

What is claimed is:

1. A method for forming an electrode of a surface light source device, comprising steps of:
contacting channel end portions of the surface light source device having a plurality of channels with a first solution and forming an electroless plating seed layer on surfaces of the channel end portions;
removing the surface light source device from contact with the first solution and heating the surface light source device; and
contacting the surface light source device with a second solution and forming a plurality of electrodes by using electroless plating.

2. The method for forming an electrode of claim 1, wherein the plurality of channels comprise two side channels and a plurality of interior channels, and wherein, in the step of forming the electroless plating seed layer, an area of the seed layer of each of the side channels is formed to be larger than an area of each of the interior channels.

3. The method for forming an electrode of claim 1, wherein, in the step of forming the electroless plating seed layer, the first solution is an aqueous solution containing Pd ions, and the electroless plating seed layer comprises Pd.

4. The method for forming an electrode of claim 1, wherein, in the step of heating the surface light source device, Sn is removed from the channel end portions.

5. The method for forming an electrode of claim 4, wherein Pd is extracted after Sn is removed.

6. The method for forming an electrode of claim 1, wherein, in the step of contacting the surface light source device with a second solution and forming an electrode by using electroless plating, the second solution comprises at least one of Cu ions, EDTA (ethylene diamine tetraacetic acid), sodium hydroxide (NaOH), or formaldehyde.

7. The method for forming an electrode of claim 6, wherein the electrode comprises Cu.

8. The method for forming an electrode of claim 1, wherein, in the step of heating the surface light source device, the surface light source device is heated at a temperature ranging from about 200° C. to about 300° C.

9. The method for forming an electrode of claim 1, further comprising cleaning the surface light source device after the step of forming an electrode.

10. A surface light source device manufactured by using the method for forming an electrode of claim 1.

11. The surface light source device of claim 10, wherein electrode areas of each of the side channels are larger than those of each of the interior channels.

12. The surface light source device of claim 11, wherein electrodes formed on the side channels are formed to extend in a longitudinal direction of the channels.

13. The surface light source device of claim 10, wherein a thickness of the electrodes is in a range of about 0.01 μm to about 1.00 μm.

14. A display device comprising:
a panel unit for displaying an image; and
the surface light source device as claimed in claim 10 for supplying light to the panel unit.

15. The display device of claim 14, wherein the panel unit is a liquid crystal display panel.
